(19) United States
(12) Patent Application Publication
(10) Pub. No.: US 2025/0350985 A1
(43) Pub. Date: Nov. 13, 2025

(54) IDENTIFYING NEAR FIELD VISIBILITY REGIONS IN A WIRELESS COMMUNICATION SYSTEM

(71) Applicant: SHARP KABUSHIKI KAISHA, Sakai City (JP)

(72) Inventors: Hitesh Poddar, Cedar Park, TX (US); Tomoki Yoshimura, Camas, WA (US)

(21) Appl. No.: 19/181,249

(22) Filed: Apr. 16, 2025

(51) Int. Cl. H04W 24/10; H04L 5/00

(52) U.S. Cl. CPC H04W 24/10; H04L 5/0051

(57) ABSTRACT

A method for a base station (BS) is provided. The method defines several basic visibility regions (VRs). Each basic VR is associated with a non-overlapping subset of the antenna ports of the BS. The method transmits a first CSI configuration that includes several CSI resource sets to a UE. Each CSI resource set identifies one or more CSI resources for one of the basic VRs. The method receives a set of channel quality measurement reports from the UE, each of which corresponds to a CSI resource set. The method then selects, for the UE, a UE-specific VR based on the set of channel quality measurement reports. The UE-specific VR includes one or more basic VRs. The method then transmits, to the UE, a second CSI configuration that includes a set of CSI resource sets, each of which identifies one or more resources for a basic VR of the UE-specific VR.

### TECHNICAL FIELD

The technology generally relates to wireless communications, and more particularly to the selection of near field visibility for a User Equipment (UE) in Multi-Input Multi-Output (MIMO) systems . . .

### BACKGROUND

Because of the tremendous growth in the number of connected devices and the rapid increase in the user/network (NW) traffic volume, various efforts have been made to improve different aspects of the wireless communications in the next-generation radio communication systems, such as the 5th generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to grow, however, there is a need for further improvements in wireless communications in the next-generation radio communication systems, such as improvements in the MIMO systems.

### SUMMARY

In a first aspect of the present application, a BS is provided. The BS includes an antenna array that includes several antenna ports. The BS includes one or more non-transitory computer-readable media storing one or more computer-executable instructions. The BS includes at least one processor that is coupled to the one or more non-transitory computer-readable media, and configured to execute the one or more computer-executable instructions to cause the BS to define several first type of visibility regions (VRs), each first type of VR in the several first type of VRs being associated with a subset of the several antenna ports of the BS; transmit, to a UE, a first channel state information (CSI) configuration that includes several CSI resource sets, each CSI resource set in the several CSI resource sets identifies one or more CSI resources for a first type of VR in the several first type of VRs; receive, from the UE, a set of one or more channel quality measurement reports, each channel quality measurement report in the set of channel quality measurement reports corresponding to a CSI resource set in the several CSI resource sets; select, for the UE, a second type of VR based on the set of one or more channel quality measurement reports, the second type of VR includes a set of one or more first type of VRs in the several first type of VRs; and transmit, to the UE, a second CSI configuration that includes a set of one or more CSI resource sets, each CSI resource set in the set of CSI resource sets identifies one or more CSI resources for a first type of VR in the set of one or more first type of VRs of the second type of VR.

In an implementation of the first aspect, the at least one processor is further configured to execute the one or more computer-executable instructions to cause the BS to receive, from the UE, a precoding matrix indicator (PMI) for the second type of VR.

In another implementation of the first aspect, the at least one processor is further configured to execute the one or more computer-executable instructions to cause the BS to receive, from the UE, a message indicating a maximum number of first type of VRs the UE is able to support, where selecting the second type of VR further includes selecting a number of first type of VRs in the second type of VR based on the maximum number of the first type of VRs the UE is able to support.

In another implementation of the first aspect, the set of one or more CSI resource sets, in the second CSI configuration, includes two or more CSI resource sets, and the CSI configuration further includes a bitmap that includes several bits, where each bit identifies whether a corresponding first type of VR in the several first type of VRs is included in the set of one or more first type VRs of the second type of VR.

In another implementation of the first aspect, each CSI resource corresponds to an antenna port of the BS.

In another implementation of the first aspect, the second CSI configuration includes a CSI resource configuration.

In another implementation of the first aspect, the second CSI configuration includes a CSI reporting configuration.

In another implementation of the first aspect, each first type of VR includes a cell-specific VR, the first type of VRs are indicated, by the BS, to the UE, through the first CSI configuration, and the first CSI configuration is transmitted to the UE during one of an initial access by the UE, a random-access by the UE, or an initial connection establishment between the UE and the BS.

In a second aspect of the present application a UE is provided. The UE includes one or more non-transitory computer-readable media storing one or more computer-executable instructions. The UE includes at least one processor coupled to the one or more non-transitory computer-readable media, and configured to execute the one or more computer-executable instructions to cause the UE to receive, from a BS that has an antenna array with several antenna ports, a first CSI configuration that includes several CSI resource sets, each CSI resource set in the several CSI resource sets identifies one or more CSI resources for a first type of VR in several first type of VRs, each first type of VR in the several first type of VRs being associated with a subset of the several antenna ports of the BS; transmit, to the BS, a set of one or more channel quality measurement reports, each channel quality measurement report in the set of channel quality measurement reports corresponding to a CSI resource set in the several CSI resource sets; and receive, from the BS, a second CSI configuration that includes a set of one or more CSI resource sets, each CSI resource set in the set of one or more resource sets identifies one or more CSI resources for a first type of VR in a set of one or more first type of VRs of a second type of VR selected, by the BS, for the UE, based on the set of one or more channel quality measurement reports.

In an implementation of the second aspect, the at least one processor is further configured to execute the one or more computer-executable instructions to cause the UE to determine a PMI for the second type of VR; and transmit, to the BS, the PMI for the second type of VR.

In another implementation of the second aspect, the set of one or more CSI resource sets, in the second CSI configuration, includes two or more CSI resource sets, and the CSI configuration further includes a bitmap that includes several bits, each bit identifies whether a corresponding first type of VR in the several first type of VRs is included in the set of one or more first type of VRs of the second type of VR.

In another implementation of the second aspect, each CSI resource corresponds to an antenna port of the BS.

In another implementation of the second aspect, the second CSI configuration includes a CSI resource configuration.

In another implementation of the second aspect, the second CSI configuration includes a CSI reporting configuration.

In a third aspect of the present application, a method performed by a BS that includes an antenna array with several antenna ports is provided. The method includes defining several first type of VRs, each first type of VR in several first type of VRs being associated with a subset of the several antenna ports of the BS; transmitting, to a UE, a first CSI configuration that includes several CSI resource sets, each CSI resource set in the several CSI resource sets identifies one or more CSI resources for a first type of VR in the several first type of VRs; receiving, from the UE, a set of one or more channel quality measurement reports, each channel quality measurement report in the set of channel quality measurement reports corresponding to a CSI resource set in the several CSI resource sets; selecting, for the UE, a second type of VR based on the set of one or more channel quality measurement reports, the second type of VR includes a set of one or more first type of VRs in the several first type of VRs; and transmitting, to the UE, a second CSI configuration that includes a set of one or more CSI resource sets, each CSI resource set in the set of CSI resource sets identifying one or more CSI resources for a first type of VR in the set of one or more first type of VRs of the second type of VR.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating an example radio communication system, according to an example implementation of the present disclosure.

FIG. 2 is a schematic diagram illustrating an example far field of an antenna array, according to an example implementation of the present disclosure.

FIG. 3 is a schematic diagram illustrating an example of several VRs of an antenna array, according to an example implementation of the present disclosure.

FIG. 4 illustrates an example of a table that lists the supported dimensions of VRs, according to an example implementation of the present disclosure.

FIG. 5 illustrates another example of a table that lists the supported dimensions of VRs, according to an example implementation of the present disclosure.

FIG. 6 is a schematic diagram illustrating an example MIMO antenna array that is divided into six basic VRs, according to an example implementation of the present disclosure.

FIG. 7 illustrates a table that shows an example mapping of the UEs to the basic VRs, according to an example implementation of the present disclosure.

FIG. 8 is a schematic diagram illustrating an example of how the BS may configure the CSI-RS resource set corresponding to each basic VR to a UE, according to an example implementation of the present disclosure.

FIG. 9 illustrates an example of the aperiodic report configuration trigger for the basic VRs, according to an example implementation of the present disclosure.

FIG. 10 illustrates an example of the aperiodic report configuration trigger for a subset of the basic VRs of the antenna array of the BS, according to an example implementation of the present disclosure.

FIG. 11 is a flowchart illustrating an example method/process performed by a BS for selecting a UE-specific VR for a UE, according to an example implementation of the present disclosure.

FIG. 12 is a flowchart illustrating an example method/process performed by a UE for receiving a UE-specific VR from a BS that has an antenna array with several antenna ports, according to an example implementation of the present disclosure.

FIG. 13 illustrates a table that shows an example mapping of the UEs to the VRs, according to an example implementation of the present disclosure.

FIG. 14 is a schematic diagram illustrating the reporting of the PMI of the UE-specific VR of each of UEs of FIG. 13, according to an example implementation of the present disclosure.

FIG. 15 is a flowchart illustrating an example method/process performed by a UE for electing a PMI for the UE-specific VR of the UE, according to an example implementation of the present disclosure.

FIG. 16 illustrates an example of a CSI related configuration, according to an example implementation of the present disclosure.

FIG. 17 is a flowchart illustrating an example method/process performed by a BS for indicating, to a UE, a second type of VR that is selected by the BS for the UE based on one or more first type of VRs, according to an example implementation of the present disclosure.

FIG. 18 is a flowchart illustrating an example method/process performed by a UE for receiving an indication of a second type of VR that is selected by the BS for the UE based on one or more first type of VRs, according to an example implementation of the present disclosure.

FIG. 19 is a block diagram illustrating a node for wireless communication, according to an example implementation of the present disclosure.

### DETAILED DESCRIPTION

Some of the abbreviations in the present application are defined as follows and, unless otherwise specified, the abbreviations have the following meanings:

| Abbreviation | Full name |
|---|---|
| 3GPP | 3rd Generation Partnership Project |
| 5G | 5th Generation |
| 5GC | 5G Core |
| ACK | Acknowledgement |
| AN-PDB | Access Network Packet Delay Budget |
| AS | Access Stratum |
| ASN.1 | Abstract Syntax Notation One |
| BFRQ | Beam Failure Recovery Request |
| BS | Base Station |
| BSR | Buffer Status Report |
| BWP | Bandwidth Part |
| C-RNTI | Cell Radio Network Temporary Identifier |
| CA | Carrier Aggregation |
| CAG | Closed Access Group |
| CB | Codebook-Based |
| CG | Configured Grant |
| CJT | Coherent Joint Transmission |
| CN | Core Network |
| CN-PDB | Core Network Packet Delay Budget |
| CORESET | Control Resource Set |
| CPE | Customer Premises Equipment |
| CRC | Cyclic Redundancy Check |
| CSI | Channel State Information |
| CSI-RS | Channel State Information Reference Signal |
| CS-RNTI | Configured Scheduling Radio Network Temporary |
| | Identifier |
| CSS | Common Search Space |
| CU | Central Unit |
| DAPS | Dual Active Protocol Stack |
| DC | Dual Connectivity |
| DCI | Downlink Control Information |
| DG | Dynamic Grant |
| DI | Delay Information |
| DL | Downlink |
| DL-SCH | Downlink Shared Channel |
| DMRS | Demodulation Reference Signal |
| DR | Delay Report |
| DRB | Data Radio Bearer |
| DTCH | Dedicated Traffic Channel |
| DU | Distributed Unit |
| ETSI | European Telecommunications Standards Institute |
| E-UTRA | Evolved Universal Terrestrial Radio Access |
| EN-DC | E-UTRA NR Dual Connectivity |
| EPC | Evolved Packet Core |
| eMBB | Enhanced Mobile BroadBand |
| eMTC | Enhanced Machine Type Communication |
| eNB | Evolved Node B |
| FDD | Frequency Division Duplexing |
| FR | Frequency Range |
| FR1 | Frequency Range 1 |
| FR2 | Frequency Range 2 |
| FWA | Fixed Wireless Access |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| ITU | International Telecommunication Union |
| L1 | Layer 1 |
| L2 | Layer 2 |
| L3 | Layer 3 |
| LAN | Local Area Network |
| LCH | Logical Channel |
| LCID | Logical Channel Identity |
| LEO | Low Earth Orbit |
| LTE | Long Term Evolution |
| LSB | Least Significant Bit |
| MAC | Medium Access Control |
| MAC CE | MAC Control Element |
| MCG | Master Cell Group |
| MCS | Modulation Coding Scheme |
| MIB | Master Information Block |
| MIMO | Multi-Input Multi-Output |
| mMTC | Massive Machine Type Communications |
| MN | Master Node |
| MTC | Machine Type Communication |
| NACK | Negative Acknowledgement |
| NAS | Non-Access Stratum |
| NB-IoT | Narrow Band Internet of Things |
| NCB | Non-Codebook-Based |
| NDI | New Data Indicator |
| NES | Network Energy Saving |
| NPN | Non-Public Network |
| NR | New Radio |
| NR-U | NR Unlicensed |
| NTN | Non-Terrestrial Network |
| PA | Power Amplifier |
| PBCH | Physical Broadcast Channel |
| PCell | Primary Cell |
| PCI | Physical Cell Identity |
| PDB | Packet Delay Budget |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PMI | Precoding Matrix indicator |
| PNI-NPN | Public Network Integrated Non-Public Network |
| PRACH | Physical Random Access Channel |
| PSDB | PDU Set Delay Budget |
| PUCCH | Physical Uplink Control Channel |
| PUSCH | Physical Uplink Shared Channel |
| QCL | Quasi-CoLocation |
| QoS | Quality of Service |
| RA | Random Access |
| RACH | Random Access Channel |
| RAN | Radio Access Network |
| RAR | Random Access Response |
| RAT | Radio Access Technology |
| RE | Resource Element |
| Rel-15 | Release 15 |
| RF | Radio Frequency |
| RLC | Radio Link Control |
| RS | Reference Signal |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| RX | Reception |
| SCell | Secondary Cell |
| SCG | Secondary Cell Group |
| SDT | Small Data Transmission |
| SI | System Information |
| SIB | System Information Block |
| SL | Sidelink |
| SLIV | Start and Length Indicator Value |
| SN | Secondary Node |
| SNPN | Stand-alone Non-Public Network |
| SpCell | Special Cell |
| SR | Scheduling Request |
| SRB | Signaling Radio Bearer |
| SRS | Sounding Reference Signal |
| SRI | SRS Resource Indicator |
| SSB | Synchronization Signal Block |
| SSS | Secondary Synchronization Signal |
| SUL | Supplementary Uplink |
| TA | Timing Advance |
| TAG | Timing Advance Group |
| TAT | Time Alignment Timer |
| TB | Transport Block |
| TCI | Transmission Configuration Indication |
| TDD | Time Division Duplexing |
| TN | Terrestrial Network |
| TPC | Transmission Power Control |
| TPMI | Transmit Precoder Matrix Indication |
| TRP | Transmission Reception Point |
| TRS | Tracking Reference Signal |
| TRX | Transmission/Reception |
| TS | Technical Specification |
| TX | Transmission |
| UCI | Uplink Control Information |
| UE | User Equipment |
| UL | Uplink |
| UL-CG | Uplink-Configured Grant |
| UPF | User Plane Function |
| URLLC | Ultra-Reliable and Low-Latency Communications |
| USIM | Universal Subscriber Identity Module |
| USS | UE-specific Search Space |
| V2X | Vehicle-to-Everything |
| VSAT | Very Small Aperture Terminal |
| XR | Extended Reality |

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (ELTE), for example, LTE connected to 5GC, NR (often referred to as 5G), LTE-A Pro, and/or a new radio system referred to as 6G. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), a 6G Node B (6gNB), and any other apparatus capable of controlling radio communication and managing radio resources within a cell. The BS may connect to serve the one or more UEs through a radio interface to the network.

The BS may be operable to provide radio coverage to a specific geographical area using one or more cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR or 6G is to support flexible configurations for accommodating various next generation communication requirements, such as Enhanced Mobile Broadband (cMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR or 6G waveform. The scalable OFDM numerology, such as the adaptive sub-carrier spacing, the channel bandwidth, and the Cyclic Prefix (CP) may also be used. Additionally, two coding schemes are considered for NR or 6G: (1) Low-Density Parity-Check (LDPC) code and (2) Polar Code. The coding scheme adaption may be configured based on the channel conditions and/or the service applications.

Moreover, it should also be noted that in a transmission time interval of a single NR or 6G frame, a DL transmission period, a guard period, and UL transmission data may at least be included, where the respective portions of the DL transmission data, the guard period, and the UL transmission data should also be configurable, for example, based on the network dynamics of NR or 6G. In addition, sidelink resources may also be provided in an NR or 6G frame to support ProSc services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Some mathematical expressions used in the present application are provided below.

Floor (CX) represents a floor function for the real number CX. For example, floor (CX) may represent a function that provides the largest integer within a range that does not exceed the real number CX.

Ceil (DX) represents a ceiling function to a real number DX. For example, ceil (DX) may be a function that provides the smallest integer within the range not less than the real number DX.

Mod (EX, FX) represents a function that provides the remainder obtained by dividing EX by FX.

Exp (GX) represents e\hat{ }GX. Here, e is the Napier number. Also, (HX)-(IX) indicates IX to the power of HX.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel typically includes several antenna elements. A beam may be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActive UplinkBWP information element (IE) field may contain the ID of the UL BWP to be activated upon performing the RRC (re-) configuration. If the firstActiveUplinkBWP IE field is absent, the RRC (re-) configuration may not impose a BWP switch. If the first active uplink BWP is configured for an SCell, the firstActiveUplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.

Panel: The UE panel information may be derived from the TCI state/UL beam indication information or from the network signaling.

Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).

TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.

TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.

TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.

Frequency Division Multiplexing (FDM) based PDSCH repetition: Multiple PDSCHs with the same TB but corresponding to two TCI states. These PDSCHs are allocated to non-overlapping frequency resources within a slot.

Multi-DCI based PDSCH scheme: Two PDCCHs from separate search spaces associated with different CORESET pool indexes that schedule the corresponding PDSCHs.

Single Frequency Network (SFN) based PDCCH scheme: A CORESET is associated with two different beams.

SFN based PDSCH scheme: A PDSCH is associated with two different beams.

Measurement objects: A list of objects on which the UE shall perform the measurements. For intra-frequency and inter-frequency measurements, a measurement object indicates the frequency/time location and subcarrier spacing of the reference signals to be measured. Associated with this measurement object, the network may configure a list of cell specific offsets, a list of exclude-listed cells and a list of allow-listed cells. The exclude-listed cells are not applicable in event evaluation or measurement reporting. The allow-listed cells are the only cells that are applicable in event evaluation or measurement reporting.

Measurement objects: A list of objects on which the UE shall perform the measurements. For intra-frequency and inter-frequency measurements, a measurement object indicates the frequency/time location and subcarrier spacing of the reference signals to be measured. Associated with this measurement object, the network may configure a list of cell specific offsets, a list of exclude-listed cells and a list of allow-listed cells. The exclude-listed cells are not applicable in event evaluation or measurement reporting. The allow-listed cells are the only cells that are applicable in event evaluation or measurement reporting.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication.” The “DL only” and “UL only” may also be referred to as a “separate TCI state,” as opposed to the “joint TCI state.”

Unified TCI states may be indicated through an RRC message, a Medium Access Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:
Single DCI based TDM PDSCH repetition;
Single DCI based FDM PDSCH repetition;
Multi-DCI based PDSCH;
TDM PDCCH repetition;
FDM PDCCH repetition;
Single DCI based TDM PUSCH repetition;
TDM PUCCH repetition;
SFN based PDCCH scheme;
SFN based PDSCH scheme;
Single DCI based FDM PUSCH repetition;
Multi-DCI based PUSCH;
FDM PUCCH repetition;
SFN based PUSCH scheme; and
SFN based PUCCH scheme.

### Selection of Near Field Visibility Regions for a UE in a MIMO System

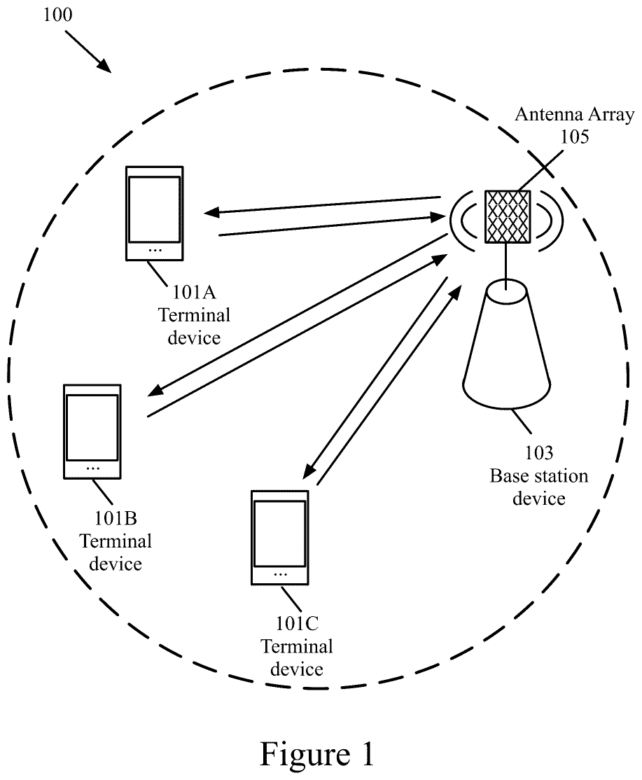

FIG. 1 is a schematic diagram illustrating an example radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

The BS 103 may include one or more transmission/reception devices. When the BS 103 is configured of multiple transmission/reception devices, each of the multiple transmission/reception devices may be arranged at a different position. A transmission/reception device may include a transmission device and/or a reception device. The BS 103 may include an antenna array 105 with multiple antenna elements. The antenna array 105, in some embodiments, may be a MIMO antenna. The MIMO antenna 105 may be used to send and receive multiple data streams simultaneously over the same frequency band, to enhances the capacity, speed, and reliability of the wireless communication.

The BS 103 may serve radio communication and provide one or more cells. A cell is defined as a set of resources used for a wireless communication. A cell may include one or both of a downlink component carrier and an uplink component carrier. A serving cell may include a downlink component carrier and two or more uplink component carriers.

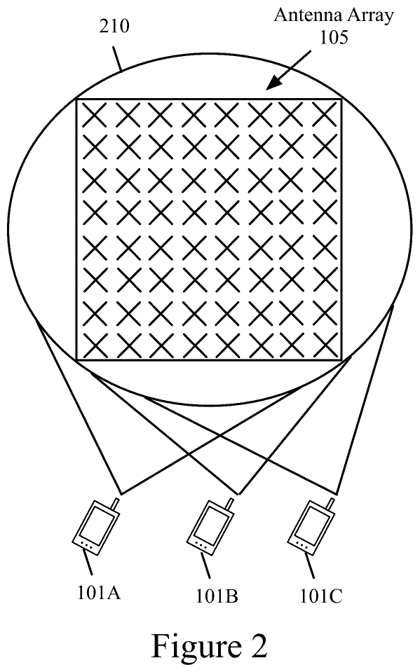

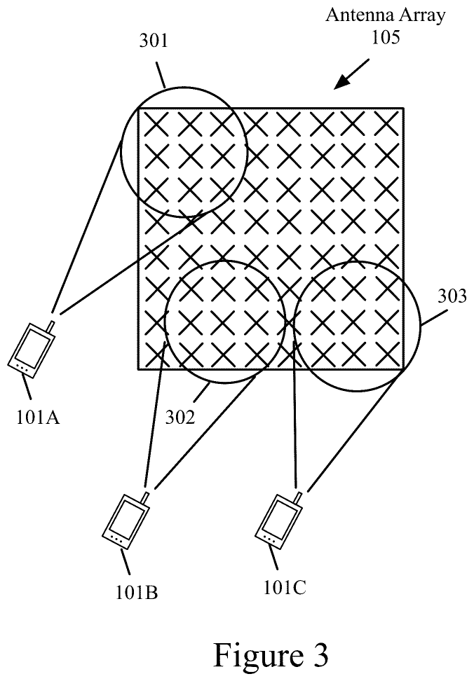

FIG. 2 is a schematic diagram illustrating an example far field of an antenna array, according to an example implementation of the present disclosure. The antenna array 105 may be the antenna array of the BS 103 shown in FIG. 3, and the UEs 101A-101C may be the UEs 101A-101C of FIG. 1. The antenna array 105 may include several antenna elements shown as Xs in FIG. 2.

In the current 3GPP implementation of the MIMO systems, the receiver (for example any of the UEs 101A-101C) assumes that it is in the far field of the MIMO antenna array (e.g., the antenna array 105) of the transmitter. Therefore, to derive the best precoder, the receiver may assume that the entire antenna array of the transmitter is visible to the receiver and the entire antenna array receives the signal power from the receiver (as shown by the area 210 which covers all elements of the antenna array 105).

However, when the receiver is in the near field of the antenna array, only certain parts of the antenna array may be visible to the receiver, and only this limited parts of the antenna array may receive most of the signal power from the receiver. This leads to the notion of visibility region (VR) as shown in FIG. 3.

FIG. 3 is a schematic diagram illustrating an example of several VRs of an antenna array, according to an example implementation of the present disclosure. As shown, when a receiver 101A, 101B, or 101C is in the near field of the antenna array 105, only limited parts of the antenna array is visible to the receiver. For example, each of the UEs 101A-101C may have a corresponding VR 301-303. As described further below, the relationship between the UEs and the VRs may be one-to-one, one-to-many, many-to-one, or many-to-many.

The current 3GPP implementation considers that the receiver is in the far field region of the antenna array, and does not use the notion of VR. The current 3GPP implementation does not provide a method for detecting or associating the VR(s) based on the near-field assumption nor does it provide a method for selection of a near field precoder based on the VR.

Some embodiments provide a method for detecting a VR for each UE in the near field. These embodiments may specify CSI configurations for each VR for every UE in the near-field, in addition to the CSI configurations for UEs in the far-field. The best near field precoder may then be selected based on the VR that is selected for the UE.

The 3GPP, Rel-19 channel modelling study for extension of TR 38.901 for near field and spatial non-stationarity has indicated that the shape of the VR may be specified as a rectangle portion of the antenna array. The size of the rectangle or VR may be based on one or more factors, such as, (1) the number of antenna elements which may be generated using a distribution, (2) the distance between the antenna array of the BS and UE/cluster, and (3) the minimum size limit for the VR.

Some embodiments may divide the MIMO antenna array in distinct, non-overlapping rectangular shaped VRs. These distinct, non-overlapping VRs are also referred to as basic VRs, configured VRs, cell-specific VRs, minimum VRs, or unit VRs. The basic VRs may be numbered, for example, from left to right and then top to bottom, or from the top to bottom and then left to right. The BS may subsequently determine the VR for each UE (e.g., based on channel quality indicator (CQI) or the signal to noise ratio (SINR) measurements reported by the UE and/or based on the capabilities of the UE). The VR for the UE may include one or more basic VRs. The VR that is selected for a UE may be referred to as UE-specific VR, effective VR, final VR, structured VR, or combined VR.

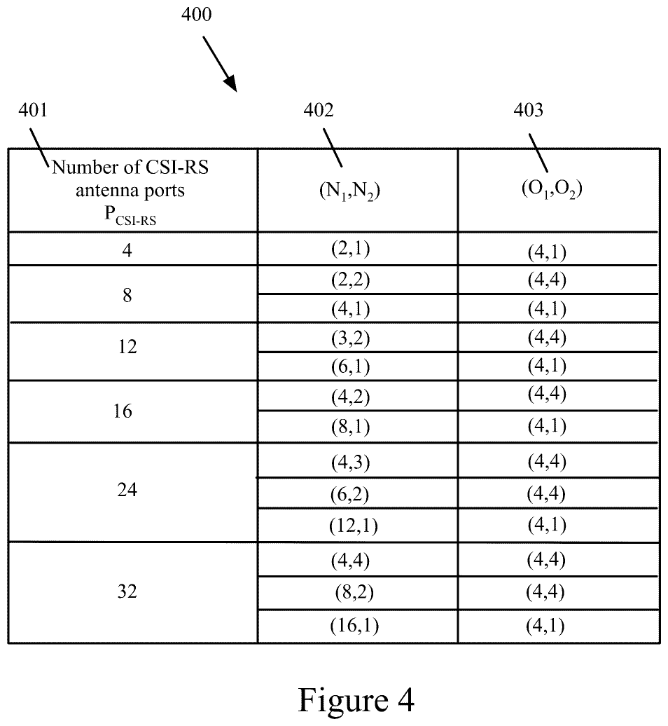

Some embodiments may require the dimensions of each basic VR region as well as the size of each UE-specific VR (that may include one or more adjacent basic VRs) to conform with one of several supported dimensions. As a non-limiting example, the size (e.g., the dimensions) of each VR region, in some embodiments, may support the configurations specified in the 3GPP Technical Specification 38.214. FIG. 4 illustrates an example of a table 400 that lists the supported dimensions of VRs, according to an example implementation of the present disclosure. Table 400 may, for example, be similar to Table 5.2.2.2.1-2 of the 3GPP Technical Specification version 15.3. As shown in FIG. 4, table 400 lists the number of supported CSI-RS antenna ports (PCSI-RS) 401, the supported N₁ and N₂ values 402, and the supported O₁ and O₂ values 403.

The LTE standard defines antenna ports 501. These antenna ports may not correspond to physical antennas, but rather are logical entities distinguished by their reference signal sequences. Multiple antenna port signals may be transmitted on a single transmit antenna. Furthermore, a single antenna port may be spread across multiple transmit antennas. An antenna port may be a logical concept that represents a transmission channel with a specific signal pattern. The CSI-RS may be transmitted on different antenna ports to allow the UE to estimate the channel separately for each port. The antenna ports may be used for different purposes, including beam management, mobility measurements, and link adaptation.

The value of N₁ and N₂ indicates the number of antenna elements in horizontal and vertical directions. The values of O₁ and O₂ indicates the discrete Fourier transform (DFT) oversampling. The O₁ and O₂ determine the sweeping steps of a beam during the beam management (e.g., beam tracking). O₁ determines the sweeping step in horizontal direction and O₂ determines the sweeping step in vertical direction.

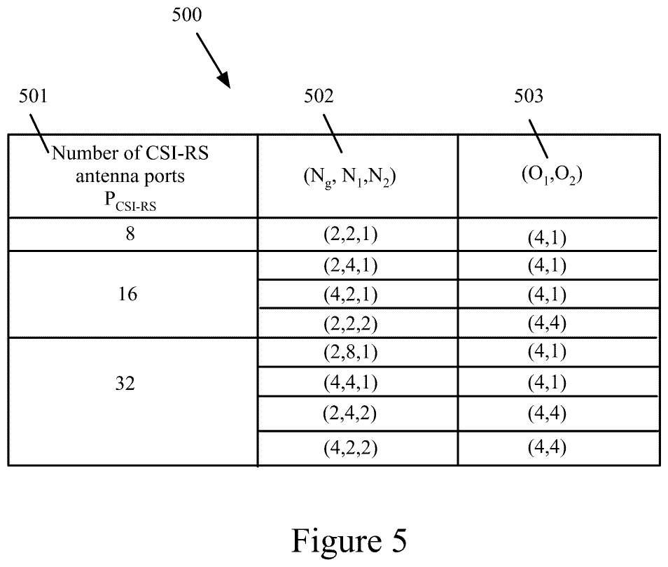

FIG. 5 illustrates another example of a table that lists the supported dimensions of VRs, according to an example implementation of the present disclosure. Table 500 may, for example, be similar to Table 5.2.2.2.2-1 of the 3GPP Technical Specification 38.214 version 15.3. As shown, table 500 lists the number of supported CSI-RS antenna ports, PCSI-RS 501, the supported Ng, N₁ and N₂ values 502, and the supported O₁ and O₂ values 503. In table 500, Ng is the number of antenna panels.

The UE-specific VR for the UE, in some embodiments, may include one or more basic VRs whose size may also support any one of the configurations of (N₁, N₂) and (O₁, O₂) as specified by table 400 shown in FIG. 4 and table 500 shown in FIG. 5. In case of multiple basic VRs, the basic VRs in the UE-specific VE should be continuous.

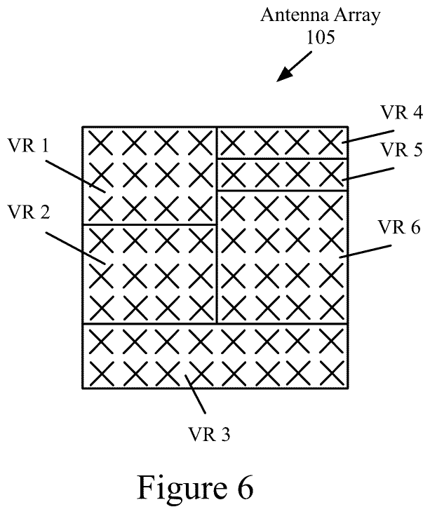

FIG. 6 is a schematic diagram illustrating an example MIMO antenna array that is divided into six basic VRs, according to an example implementation of the present disclosure. The MIMO antenna array 105 may be divided into six distinct non-overlapping rectangular shaped basic VRs shown as VR 1 to VR 6. In the example of FIG. 6, the VRs are numbered top to bottom and left to right.

The size of each of the six basic VRs corresponds to one of the supported configurations of (N₁, N₂) tuples in table 400 shown in FIG. 4. For example, VR 1, VR 2 are of same size (4, 3) each. VR 3 is (8, 2), VR 4 is (4, 1), VR 5 is (4, 1) and VR 6 is (4, 4). Each antenna element in FIG. 6 is shown by an X. In the example of FIG. 6, each antenna element may include, for example, 2 antenna ports.

The UE-specific VR selected for the UE may be one of the following: (1) any one of the basic VRs selected from the six distinct VRs. For example, the UE-specific VR for the UE may be either one of VR 1 to VR 6 or (2) a combination of any of the six distinct basic VRs such that the size of the combined VRs results in one of the supported configurations of (N₁, N₂) in table 400 shown in FIG. 4.

For example, basic VR 4 of size (4, 1) and basic VR 5 of size (4, 1) may be combined to form the UE-specific VR of the UE. The size of the UE-specific VR, after combining VR 4 and VR 5, becomes (4, 2) which is one of the supported configurations of (N₁, N₂) in table 400. However, any other combination of the basic VRs in this example may lead to a size of (N₁, N₂) which is not supported in table 400 and thus may not form the UE-specific VR.

For example, if basic VR 1 of size (4, 3) and basic VR 2 of size (4, 3) are combined, the size of the UE-specific VR, after combining basic VR 1 and basic VR 2, is (4, 8) which is not a supported configuration of (N₁, N₂) in table 4. Hence, basic VR 1 and basic VR 2 may not be combined to form the UE-specific VR. Also, in a case that any number of basic VRs (e.g., basic VRs 1 to 6 shown in FIG. 6) is combined to result in a UE-specific VR size that is supported by a (N₁, N₂) in table 400, but the basic VRs were not continuous, the combination of the basic VRs may not be used as the UE-specific VR. Thus, in a scenario where either the size of the UE-specific VR is not a supported configuration, or the basic VRs being combined are non-continuous, the combined VR may not be used to form the UE-specific VR.

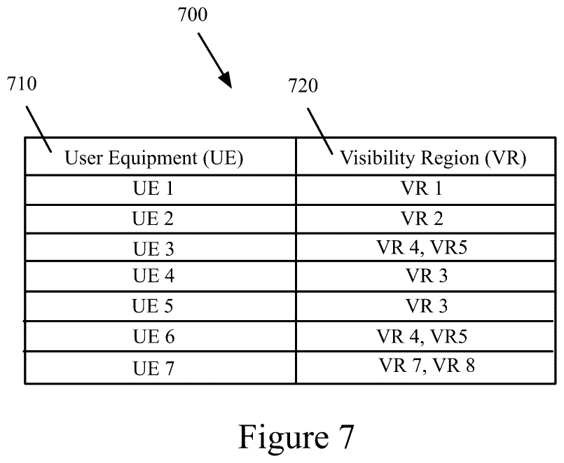

Some embodiments may provide a method to associate one or more UEs with one or more basic VRs. The most common mapping of the UE(s) to the basic VR(s) may be that one or more UEs are associated to one or more basic VRs. FIG. 7 illustrates a table that shows an example mapping of the UEs to the basic VRs, according to an example implementation of the present disclosure. In the example of FIG. 7, table 700 illustrates one possible mapping of the UEs 710 to the basic VRs 720 in a system that includes seven UEs and a BS with a MIMO antenna array with eight basic VRs.

As shown by table 700, the UE(s) to the basic VR(s) mappings may be (1) one-to-one (e.g., UE 1 to basic VR 1 or UE 2 to basic VR 2), (2) many-to-one (e.g., UE 4 and UE 5 to basic VR 3), one-to-many (e.g., UE 7 to basic VR 7 and basic VR 8), and many-to-many (e.g., UE 3 and UE 6 to basic VR 4 and basic VR 5). It this example, it is assumed that each of the combination of basic VR 4 and basic VR 5, and the combination of basic VR 7 and basic VR 8 are continuous, and the two dimensions of each combination is supported in table 400 shown in FIG. 4.

### Mapping of the UEs to the VRs

Some embodiments may determine a UE-specific VR for a UE in several steps, as described below. In the first step, the BS (e.g., the gNB) may map the UEs to one or more basic VRs. To map the UE to the basic VR(s), the following approach may be used.

The BS may configure the CSI-ReportConfig for each basic VR. Consider there are 1, 2, . . . , M basic VRs. Then, the RRC configuration sent from the BS to the UE may look like the following:

```
  Csi-ReportConfigToAddModList
    ReportConfig
      reportConfigId: 1 --------- legacy CSI-RS configuration
    ReportConfig
      reportConfigId: 2 - CSI-RS Resource Set 1 --- CSI-RS configuration for VR 1
    ReportConfig
      reportConfigId: 3 - CSI-RS Resource Set 2 --- CSI-RS configuration for VR 2
    ReportConfig
      reportConfigId: M - CSI-RS Resource Set M --- CSI-RS configuration for VR
M
```

In the above example, each CSI-RS resource set 1 to M may correspond to one of the basic VRs 1 to M.

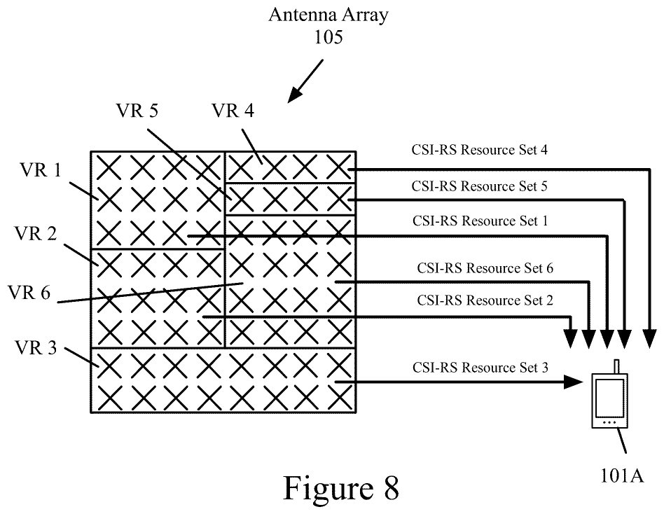

FIG. 8 is a schematic diagram illustrating an example of how the BS may configure the CSI-RS resource set corresponding to each basic VR to a UE, according to an example implementation of the present disclosure. As shown, the BS may map the CSI-RS resource sets 1-6 that correspond to each one of basic VR 1-6, respectively, to the UE 101A.

The BS may configure the Report Configuration for the basic VRs using the following legacy approaches: (1) in a case that the Report Configuration, which is sent from the BS to the UE, is periodic, the resource configuration, which is sent from the UE to the BS, has to be periodic as well, (2) in a case that the Report configuration is semi-persistent (e.g., semi periodic), the Resource Configuration may be either periodic or semi persistent, and (3) in a case that the Report configuration is aperiodic, the Resource Configuration may be any type, for example, periodic, semi periodic, or aperiodic.

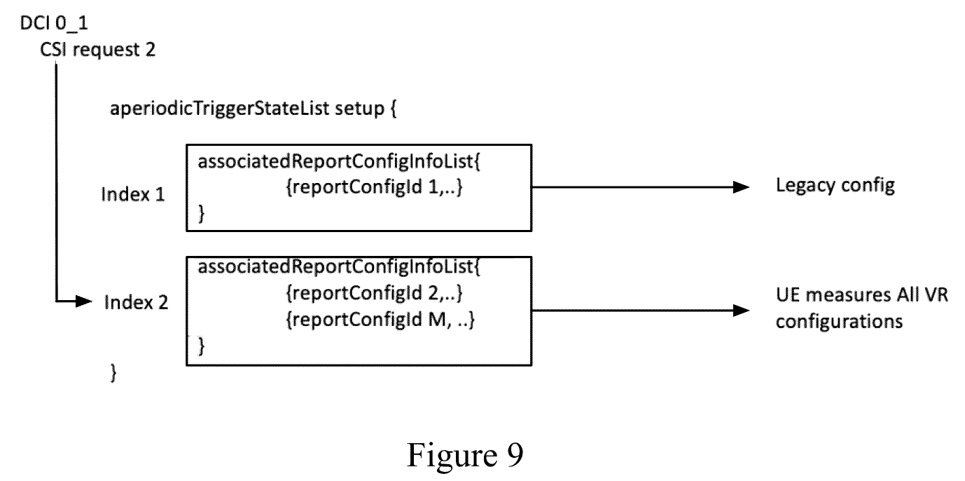

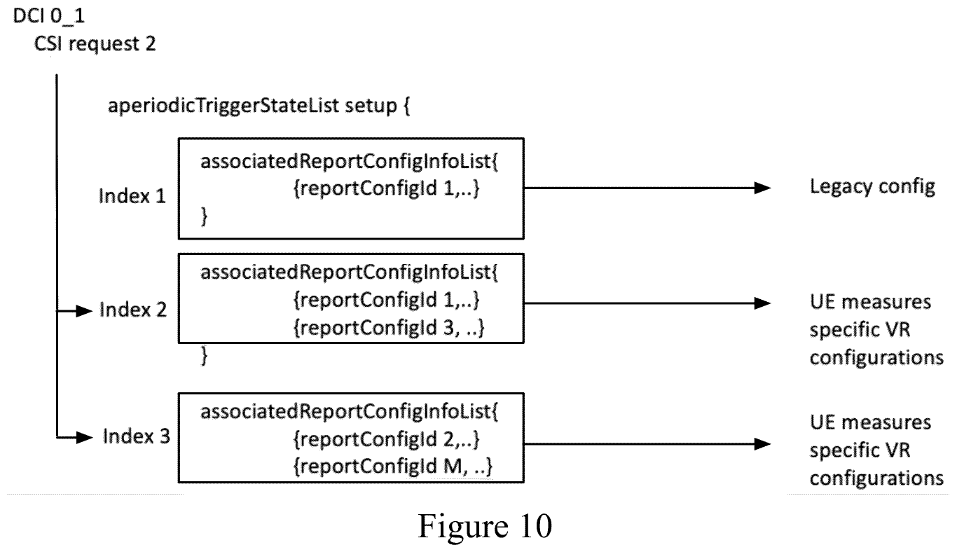

In the case that the Report configuration is aperiodic, the aperiodic reporting of the Resource Configuration may be preferred. Similar to the legacy approach, the BS may trigger the aperiodic report configuration for the basic VRs using DCI 0_1->CSI request as shown in FIGS. 9 and 10.

FIG. 9 illustrates an example of the aperiodic report configuration trigger for the basic VRs, according to an example implementation of the present disclosure. As shown in FIG. 9, when index 1 is triggered, the UE may measure the CSI-RS resource set associated with the legacy configuration (e.g., for the entire antenna array of the BS). When index 2 is triggered, the UE may measure all CSI-RS resource sets for every basic VR. In this example, the UE may measure the CSI-Resource sets corresponding to VR 1, VR 2, VR 3, . . . , VR M. The conditions to trigger the aperiodic report configuration may depend on the BS. For example, the BS may trigger the aperiodic reporting request whenever the BS determines that the UE is in the near field.

FIG. 10 illustrates an example of the aperiodic report configuration trigger for a subset of the basic VRs of the antenna array of the BS, according to an example implementation of the present disclosure. As shown in FIG. 10, when index 1 is triggered, the UE may measure the CSI-RS resource set associated with the legacy configuration (e.g., for the entire antenna array of the BS). When index 2 or index 3 is triggered, the UE measures only specific CSI-RS resource corresponding to certain basic VRs. In the example of FIG. 10, the UE measures the CSI-Resource sets corresponding to VR 1 and VR 3 only.

### Reporting the Channel Quality Measurement Report by the UE

In the first step, the UE may report the channel quality measurements. The channel quality measurements may, for example, be the CQI or the SINR. The UE may report the channel quality measurements using one of the following options:
Option 2-1—The UE may report the CQI or the SINR for all CSI-RS resource sets (e.g., all basic VRs) configured by the BS.
Option 2-2: The UE may report the CQI or the SINR for the top N CSI-RS resource sets corresponding to a top N basic VRs configured by the BS. The number N may be determined by the UE as follows:
Option 2-2-1: N may be randomly selected every time and may be greater than or equal to 1.
Option 2-2-2: N may be a fixed number that is greater than or equal to 1.
Option 2-2-3: N may be the number of basic VRs which satisfy one or more conditions.

For example, the SINR of the strongest basic VRs are larger than a fixed threshold. N may be a fixed number that is greater than or equal to 1

### Determination of the Basic VR(s) for the UE by the BS

In the third step, the BS may determine the appropriate basic VR(s) for the UE. For example, based on the reported CQI or SINR by the UE, the BS may determine the appropriate basic VR(s) for the UE. If the UE used Option 2-1, described above, then the CQI or SINR for the basic VRs not selected for the UE may be lower than that of the other basic VRs. In contrast, if the UE used Option 2-2, described above, then the reported CQI or SINR may be high and may correspond to the strongest N distinct basic VRs. However, irrespective of the options (Option 2-1 or Option 2-2) used by the UE to report CQI or SINR, it is the BS's final decision to associate the UE to one or more basic VRs.

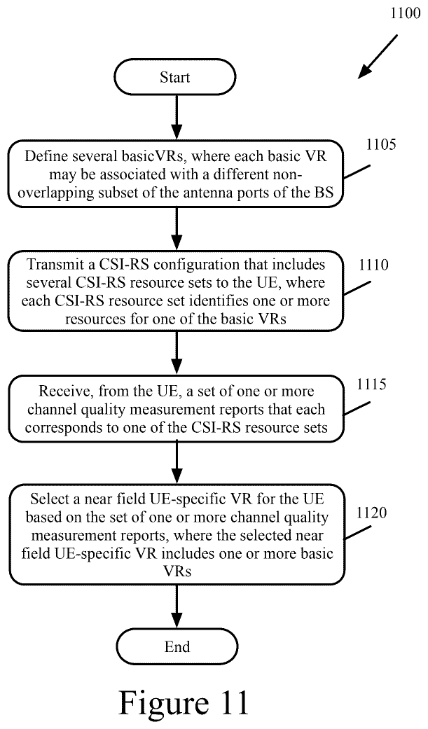

FIG. 11 is a flowchart illustrating an example method/process 1100 performed by a BS for selecting a near field UE-specific VR for a UE, according to an example implementation of the present disclosure. With reference to FIG. 11, the process 1100 may be performed by at least one processor of a BS, such as the BS 103, shown in FIG. 1.

The process 1100 may define (at block 1105) several unique basic VRs such that each basic VR be associated with a different non-overlapping subset of the antenna ports of the BS. Each VR, in some embodiments, may correspond to a two dimensional array of antenna ports in the antenna ports of the BS.

The BS, in some embodiments may store a list of supported VR dimensions that identify several VR dimensions supported by the BS. For example, the BS may store table 400 shown in FIG. 4 and/or table 500 shown in FIG. 5. The VRs defined by the process 1100 in these embodiments may include dimensions that are identified by the list of supported VR dimensions.

The process 1100 may transmit (at block 1110), to the UE, a CSI-RS configuration that may include several CSI-RS resource sets. Each CSI-RS resource set may identify one or more resources for one of the basic VRs. The CSI-RS configuration, in some embodiments, may further include a CSI-RS resource set configuration (e.g., a legacy CSI-RS resource set configuration) that identifies one or more resources for all antenna ports of the BS.

The process 1100 may receive (at block 1115), from the UE, a set of one or more channel quality measurement reports that each corresponds to one of the CSI-RS resource sets. Each channel quality measurement report, in some embodiments, may be either a CQI or a SINR.

The process 1100 may select (at block (1120) a near field UE-specific VR for the UE based on the set of one or more channel quality measurement reports. The selected near field UE-specific VR may include one or more basic VRs. The process 1100 may then end.

The antenna ports of the BS antenna, in some embodiments, may be arranged in a two dimensional array. The process 1100 may assign a number to each of the basic VRs in an order that is determined based on the horizontal position of the basic VR, or the vertical position of the basic VR, in the two dimensional array of the antenna ports of the BS antenna. The assigned numbers of the basic VRs may be used by the UE to determine the dimension of the near field UE-specific VR that is selected, by the BS, for the UE and determine a PMI for the selected near field UE-specific VR based on the dimension of the near field UE-specific VR.

The UE-specific VR may include a combination of one or more adjacent basic VRs. The dimensions of the UE-specific VR may be one of the VR dimensions that are identified by the list of supported VRs. For example, the dimensions of the UE-specific VR may be one of the VR dimensions that are identified by table 400 shown in FIG. 4, or table 500 shown in FIG. 5.

The UE-specific VR, in some embodiments, may include the combination of two or more adjacent basic VRs. The process 1100, in these embodiments, may select the same near field VR for several UEs. In some embodiments, the process 110 may select only one basic VR of the multiple basic VRs of the antenna array of the BS as the UE-specific VR for a UE. The process 1100, in these embodiments, may select the same UE-specific VR for several UEs.

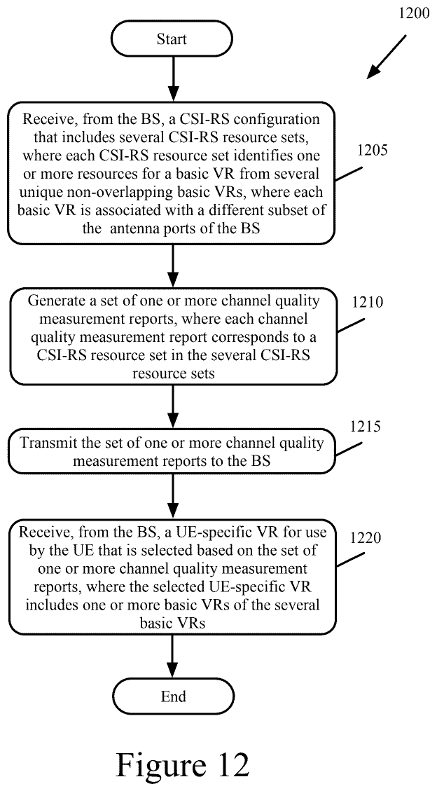

FIG. 12 is a flowchart illustrating an example method/process 1200 performed by a UE for receiving a near field UE-specific VR from a BS that has an antenna array with several antenna ports, according to an example implementation of the present disclosure. With reference to FIG. 12, the process 1200 may be performed by at least one processor of a UE 101A-101C, shown in FIG. 1.

The process 1200 may receive (at block 1205), from the BS, a CSI-RS configuration that includes several CSI-RS resource sets. Each CSI-RS resource set may identify one or more resources for a basic VR from several unique non-overlapping basic VRs. Each basic VR may be associated with a different subset of the antenna ports of the BS. The process 1200, in some embodiments, may receive the CSI-RS configuration from the BS through an RRC message.

The process 1200 may generate (at block 1210) a set of one or more channel quality measurement reports. Each channel quality measurement report may correspond to a CSI-RS resource set in the several CSI-RS resource sets. The set of channel quality reports, in some embodiments, may include the same number of channel quality reports as the number of CSI-RS resource sets in the several CSI-RS resource sets. The number of channel quality reports, in some embodiments, may be less than the number of CSI-RS resource sets of the several CSI-RS resource sets. In these embodiments, the number of the channel quality reports may be either a fixed number, a randomly selected number, or a number that is based on a quality of signals measured by the UE for each channel quality report. In these embodiments, the number of the channel quality reports is greater than or equal to one.

The process 1200 may transmit (at block 1215) the set of one or more channel quality measurement reports to the BS. When receiving the CSI-RS configuration from the BS is periodic, the process 1200 may periodically transmit the set of one or more channel quality measurement reports to the BS. When receiving the CSI-RS configuration from the BS is periodic or semi-persistent, the process 1200 may (1) periodically transmit the set of one or more channel quality measurement reports to the BS or (2) semi-persistently transmit the set of one or more channel quality measurement reports to the BS.

When receiving the CSI-RS configuration from the BS is aperiodic, the process 1200 may (1) periodically transmit the set of one or more channel quality measurement reports to the BS, (2) semi-persistently transmit the set of one or more channel quality measurement reports to the BS, or (3) aperiodically transmit the set of one or more channel quality measurement reports to the BS. In some embodiments, when receiving the CSI-RS configuration from the BS is aperiodic, the process 1200 may aperiodically transmit the set of one or more channel quality measurement reports to the BS

The process 1200 may receive (at block 1220), from the BS, a UE-specific VR for use by the UE. The UE-specific VR may be selected by the BS based on the set of one or more channel quality measurement reports. The UE-specific VR selected for the UE may include one or more basic VRs of the several basic VRs of the antenna array of the BS. The process 1200 may then end.

### Selection of the Best Near Field Precoder for the UE-Specific VR

The UE, in some embodiments, may select the best near field precoder based on the UE-specific VR that the BS has selected for the UE and may send the precoder to the BS. The UE needs to know the BS's decision on which CSI RS resource set(s) (e.g., which basic VR or which combination of basic VRs) may form the UE-specific VR for the UE in order for the UE to report the precoding matrix indicator (PMI) for the UE-specific VR.

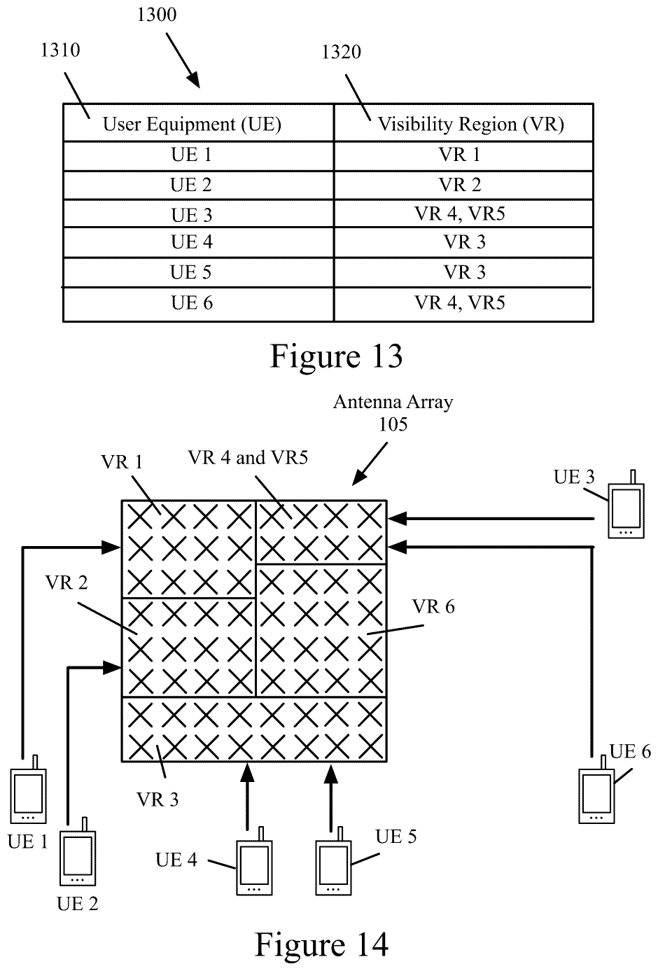

Reporting the PMI corresponding to the UE-specific VR of the UE is important because the BS may use only the UE-specific VR for data communication. For example, based on the individual CQI or SINR reported by the UE in the CSI report for VR 4 and VR 5, the BS may determine that the CSI-RS resource set 4 (corresponding to VR 4) and the CSI-RS resource set 5 (corresponding to VR 5) are the strongest basic VRs for the UE. Therefore, the BS may decide to combine VR 4 and VR 5 to form the UE-specific VR for the UE and may ask the UE to report the PMI of the UE-specific VR which includes of the combination of basic VR 4 and basic VR 5 as shown in FIG. 13.

FIG. 13 illustrates a table that shows an example mapping of the UEs to the VRs, according to an example implementation of the present disclosure. In the example of FIG. 12, table 1300 illustrates one possible mapping of the UEs 1310 to the VRs 1320 in a system that includes six UEs and a BS with a MIMO antenna array associated with six basic VRs. It should be noted that the size of the UE-specific VR for the UEs in table 1300 is one of the supported configurations of (N₁, N₂) shown in table 400 in FIG. 4.

FIG. 14 is a schematic diagram illustrating the reporting of the PMI of the UE-specific VR of each of UEs of FIG. 13, according to an example implementation of the present disclosure. As shown in FIG. 14, each UE may report the PMI of its UE-specific VR using the CSI-RS resource set the UE received from the BS for the UE-specific VR of the UE.

The UE may determine the PMI for the UE-specific VR by knowing which distinct basic VRs (e.g., VR 4 and VR 5 for the UE 3 or UE 6) form the UE-specific VR for the UE and how are the basic VRs numbered. For example, when the basic VRs are numbered top to bottom and left to right, the combination of basic VR 4 and basic VR 5 in FIG. 14 (which are each 1 by 4) may result in a 2 by 4 combined VR, as basic VR 4 is positioned on top of basic VR 5. On the other hand, when the numbering is left to right and top to bottom, the combination of two 1 by 4 basic VRs may result in a 1 by 8 combined VR, as the two basic VRs may be side to side adjacent to each other.

The BS may request the UE to report the PMI for the UE-specific VR of the UE using the CSI-RS resource set(s) the BS determines to form the UE-specific VR of the UE in the following ways. If the UE-specific VR of the UE includes only one basic VR, then the UE may report the PMI in the corresponding CSI-RS resource set of that basic VR. For example, if the BS determines for UE 4 that the UE-specific VR only includes basic VR 3, then UE 4 may report the PMI for its UE-specific VR, which only includes basic VR 3, by using CSI-RS resource set 3.

If the UE-specific VR of the UE includes multiple basic VRs, then the UE may report the PMI using one of the following two options: Option 2-1 and Option 2-2. In Option 2-1, the UE may use either one or both CSI-RS resource sets that form the UE-specific VR of the UE to report the PMI. For example, if the BS determines for UE 3 that the UE-specific VR includes basic VR 4 and basic VR 5, then UE 3 may report the PMI for its UE-specific VR using either CSI-RS resource set 4 or CSI-RS resource set 5 or it may report the PMI on both CSI-RS resource set 4 and CSI-RS resource set 5.

In Option 2-2, one of the CSI-RS resource sets with the highest CQI or SINR may be used by the UE to report the PMI to the BS. For example, if the BS determines for UE 3 that the UE-specific VR includes basic VR 4 and basic VR 5, then UE 3 may report the PMI for its UE-specific VR on either CSI-RS resource set 4 or CSI-RS resource set 5, whichever CSI-RS resource set among CSI-RS resource set 4 or CSI-RS resource set 5 has a higher CQI.

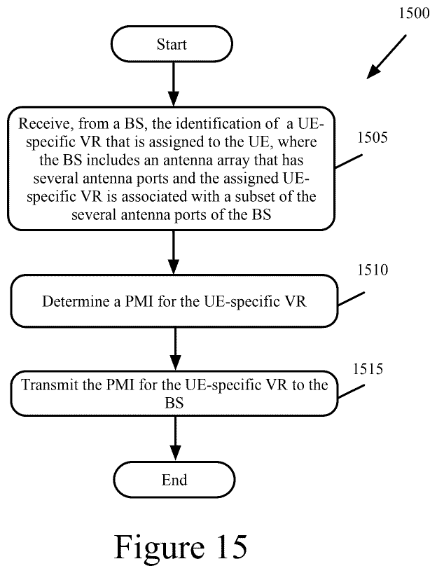

FIG. 15 is a flowchart illustrating an example method/process 1500 performed by a UE for electing a PMI for the UE-specific VR of the UE, according to an example implementation of the present disclosure. With reference to FIG. 15, the process 1500 may be performed by at least one processor of a UE 101A-101C, shown in FIG. 1.

The process 1500 may receive (at block 1505), from a BS, the identification of a UE-specific VR that is assigned to the UE. The BS may include an antenna array that has several antenna ports, and the assigned VR may be associated with a subset of the antenna ports of the BS.

The BS, in some embodiments, may define several basic VRs. Each basic VR of the several basic VRs may be associated with a different non-overlapping subset of the several antenna ports of the BS. The UE-specific VR assigned to the UE may include a combination of two or more adjacent basic VRs of the several basic VRs.

The process 1500 may determine (at block 1510) a PMI for the UE-specific VR. The antenna ports of the BS antenna, in some embodiments, may be arranged in a two dimensional array. The BS may define several basic VRs. Each basic VR may be associated with a different non-overlapping subset of the antenna ports of the BS. The BS may assign a number to each of basic VRs in an order that is determined based on the horizontal position of each basic VR, or the vertical position of each basic VR, in the two dimensional array. The UE-specific VR assigned to the UE, in some embodiments, may include a combination of several adjacent basic VRs. The process 1500, in these embodiments, may use the numbers assigned to the adjacent basic VRs of the UE-specific VR to determine the dimension of the UE-specific VR, and may determine the PMI for the UE-specific VR based on the dimension of the UE-specific VR.

The process 1500 may transmit (at block 1515) the PMI for the UE-specific VR to the BS. The process 1500 may then end. The process 1500, in some embodiments, may transmit the PMI to the BS in a CSI-RS resource set that corresponds to one of the basic VRs in the combination of two or more adjacent basic VRs. In some embodiments, the CSI-RS resource set in which the PMI is transmitted includes the best channel quality measurement. The channel quality measurement, in some embodiments, may include either a CQI or a SINR. The CSI-RS resource set that is used to transmit the PMI may be one of the several CSI-RS resource sets that are received from the BS in a CSI-RS resource configuration. Each CSI-RS resource set of the several of CSI-RS resource sets may correspond to a basic VR of the several basic VRs.

The BS, in some embodiments, may define several basic VRs. Each basic VR may be associated with a different subset of the several antenna ports of the BS. The UE-specific VR assigned to the UE may include a combination of several adjacent basic VRs. The process 1500, in these embodiments, may transmit the PMI to the BS in several CSI-RS resource sets. Each CSI-RS resource set of the several CSI-RS resource sets may correspond to a basic VR of the several adjacent basic VRs.

The BS, in some embodiments, may define several non-overlapping basic VRs. Each basic VR may be associated with a different non-overlapping subset of the antenna ports of the BS. The UE-specific VR that is assigned to the UE may include only one basic VR of the several basic VRs. The process 1500, in these embodiments, may transmit the PMI to the BS in a CSI-RS resource set that corresponds to the UE-specific VR. The PMI may be used by the BS to perform beamforming for the antenna ports of the BS antenna that correspond to the UE-specific VR. In some embodiments, the process 1500 may transmit the PMI to the BS in either a PUCCH or a PUSCH.

The process 1500, in some embodiments, may receive several reference signals from the BS and may perform CSI measurements on the reference signals. The process 1500 may estimate a channel precoding matrix based on the CSI measurements. The process 1500 may select a precoding matrix from several predefined channel precoding matrixes based on the estimated channel matrix. The PMI may include an index to the selected precoding matrix. The process 1500, in some embodiments, may aperiodically transmit the PMI to the BS based on one or more changes in CSI measurements. The process 1500, in some embodiments, may periodically transmit the PMI to the BS.

### Indication of the UE-Specific VR to the UE

Once the BS determines the UE-specific VR for the UE, the BS may communicate this information to the UE to enable the UE to select the appropriate near field precoder for the UE-specific VR for CSI reporting. Additionally, the UE may also indicate to the BS on the maximum number of basic VRs that the UE is able to support. The maximum number of basic VRs that the UE is able to support may be used by the BS to correctly determine the UE-specific VR for the UE. Some embodiments provide methods by which the BS may indicate to the UE which basic VR(s) constitute the UE-specific VR for the UE. In some embodiments, the UE may report capability parameters related to VR measurement and reporting to the BS. For example, the UE may communicate, to the BS, the maximum number of basic VRs the UE is able to support.

As described above with reference to FIG. 14, the BS may determine the UE-specific VR for each UE based on CQI or SINR reported by the UE for the basic VRs. The BS may indicate, to the UE, which of the basic VRs form the UE-specific VR. The UE-specific VR of the UE may include one or more distinct non overlapping basic VRs as shown in FIG. 14. For example, for UE 3 the UE-specific VR includes two distinct, non-overlapping basic VRs namely, basic VR 4 and basic VR 5. On the other hand, the UE-specific VR for UE 5 includes only one basic VR which is basic VR 3. Therefore, the BS may indicate to each UE the corresponding UE-specific VR. For example, the BS may indicate, to UE 3, that the UE-specific VR for UE 3 includes basic VR 4 and basic VR 5, while the BS may indicate, to UE 5, that the UE-specific VR for UE 5 includes only of basic VR 3.

The BS may indicate to the UE the basic VRs that are included in the UE-specific VR of the UE in one of the following ways. The UE-specific VR configuration may be provided per CSI reporting configuration (e.g., in each CSI-reportConfig). In this case, the BS may implicitly indicate the UE-specific VR through DCI or MAC CE indicating the CSI report configuration index. Alternatively, the UE-specific VR configuration may be provided per CSI resource configuration (e.g., in each CSI-resourceConfig). In this case, additional functions to support dynamic switching of the UE-specific VR configuration through DCI or MAC CE may also be supported. Alternatively, the BS may indicate the UE-specific VR configuration to the UE through RRC signaling.

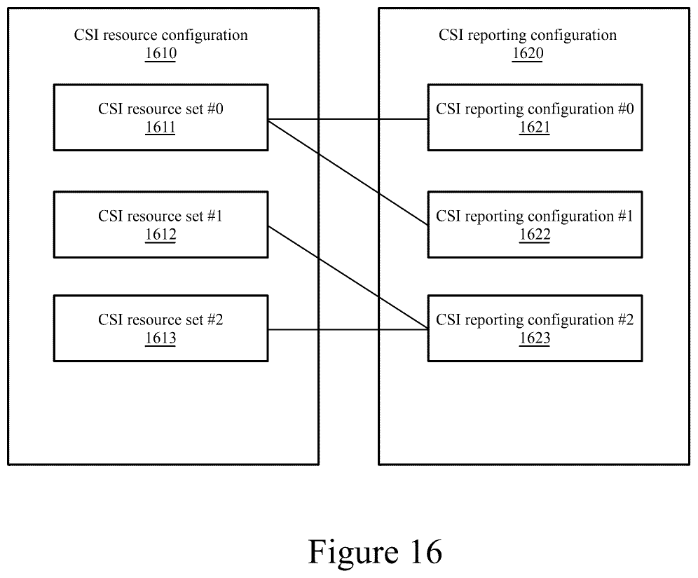

FIG. 16 illustrates an example of a CSI related configuration, according to an example implementation of the present disclosure. The CSI related configuration may include the CSI resource configuration 1610 and the CSI reporting configuration 1620.

The CSI resource configuration 1610 may include one or more CSI resource set configurations 1611-1613. In the example of FIG. 16, three CSI resource sets with indexes #0 to #2 are shown. Each CSI resource set 1611-1613 may include one or more CSI resources that may include a number of CSI-RS antenna ports.

Each CSI resource set 1611-1613 may be associated with one basic VR. For example, CSI resource set #0 1611 may include the CSI-RS configuration for basic VR 1, CSI resource set #1 1612 may include the CSI-RS configuration for basic VR 4, and CSI resource set #2 1613 may include the CSI-RS configuration for basic VR 5.

On the other hand, CSI reporting configuration 1620 may include configuration for CSI reporting. The CSI reporting configuration 1620 may include uplink channel configuration for CSI reporting. The CSI reporting configuration 1620 may include CSI contents to be reported. For example, CSI contents may be CQI, PMI, RI, or RSRP. In this way, the UE may be configured with multiple different CSI reporting contents with different uplink channels.

Another component necessary for reporting CSI is the CSI resource set to measure. Therefore, each CSI reporting configuration 1621-1623 may be associated with one or more CSI resource sets 1611-1613. In FIG. 16, the lines between the CSI resource sets 1611-1613 and the CSI reporting configurations 1621-1623 show the association.

In this way, a UE-specific VR may be implicitly derived by the association. For example, the UE-specific VR for CSI reporting configuration #2 1623 may be basic VR 4 and basic VR 5, assuming that CSI resource set #1 1612 is associated with basic VR 4 and CSI resource set #2 1613 is associated with VR 5. On the other hand, CSI reporting configuration #0 1621 and CSI reporting configuration #1 1622 do not combine more than one basic VR since they are associated with only one CSI resource set.

In a case that CSI resource set #0 1611 includes multiple basic VRs, the CSI reporting configuration 1610 may include an explicit indicator for the basic VRs that are included in the UE-specific VRs. For example, in a case that the CSI resource set #0 1611 may include configurations for any basic VR from VR 1 to VR 6, a 6-bit bitmap may be additionally provided in each CSI reporting configuration. For example, a bitmap with ‘110000’ in the CSI reporting configuration #0 1621 may represent the combined VR being basic VR 1 and basic VR 2, and a bitmap with ‘000110’ in the CSI reporting configuration #1622 may represent the combined VR being basic VR 4 and basic VR 5.

In some embodiments, the UE-specific VR configuration may be provided in the CSI resource configuration 1600. For example, each CSI resource set configuration 1611-1613 may include the UE-specific VR configuration. The UE-specific VR configuration may be a bitmap, as described above.

In some embodiments, the UE may also report the UE capability on how many basic VRs the UE is able to support in the UE-specific VR before the BS may decides on the number of basic VRs that form the UE-specific VR of the UE. For example, if UE 5 in FIG. 14 indicates that it is only able to support one basic VR, then the BS may not indicate a UE-specific VR to the UE that includes both basic VR 4 and basic VR 5. The BS may choose either one of basic VR 4 or basic VR 5 as the UE-specific VR for the UE. Additionally, the BS may also select a completely different basic VR than the basic VR 4 or basic VR 5. For instance, the BS may select basic VR 1 as the UE-specific VR for UE 5.

Once the BS indicates to the UE which basic VR(s) form the UE-specific VR for the UE, the UE may determine the near field precoder (PMI) for the combined VR and report it to the BS.

The basic VR may be a cell-specific VR. For example, the basic VR configuration may be provided by system information or cell-specific RRC signaling. For example, the basic VR configuration may be provided before or during the initial access, the random access, or the initial connection establishment. In some embodiments, the BS may indicate a subset of all basic VRs to a UE to monitor. In some embodiments, the UE-specific VR may be specifically configured to the UE. For example, the UE-specific VR may be identified by UE-specific RRC configuration.

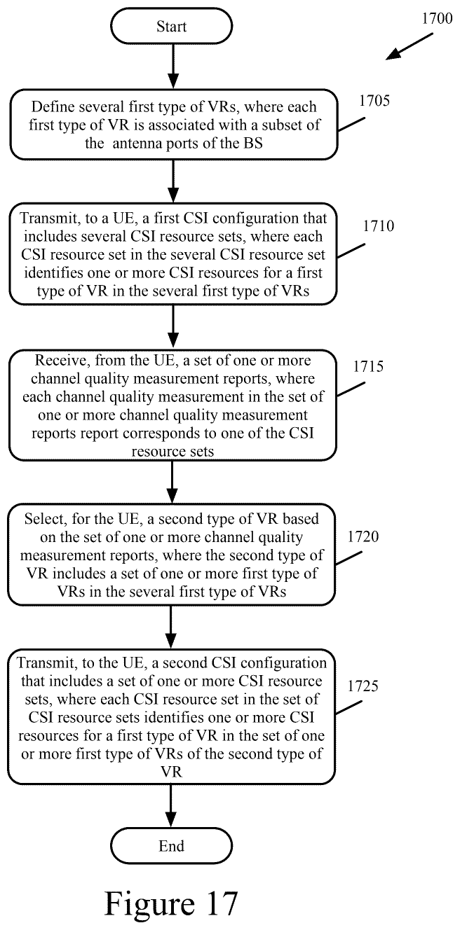

FIG. 17 is a flowchart illustrating an example method/process 1700 performed by a BS for indicating, to a UE, a second type of VR that is selected by the BS for the UE based on one or more first type of VRs, according to an example implementation of the present disclosure. With reference to FIG. 17, the process 1700 may be performed by at least one processor of a BS 103, shown in FIG. 1. The BS may include an antenna array with several antenna ports.

The process 1700 may define (at block 1705) several first type of VRs. Each first type of VR may be associated with a subset of the antenna ports of the BS. The first type of VR, in some embodiments, may be a basic VR. In some embodiments, the subsets of the antenna ports of the BS that are associated with each first type of VR may be non-overlapping.

The process 1700 may transmit (at block 1710), to the UE, a first CSI configuration that includes several CSI resource sets. Each CSI resource set in the several CSI resource sets identifies one or more CSI resources for a first type of VR in the several first type of VRs. Each CSI resource may correspond to an antenna port of the BS.

Each first type of VR, in some embodiments, may be a cell-specific VR. The several first type of VRs may be indicated, by the BS, to the UE, through the first CSI configuration. The first CSI configuration may be transmitted to the UE during one of the initial access by the UE, a random-access by the UE, or the initial connection establishment between the UE and the BS.

The process 1700 may receive (at block 1715), from the UE, a set of one or more channel quality measurement reports, where each channel quality measurement report in the set of one or more channel quality measurements reports corresponds to one of the CSI resource sets in the several CSI resource sets.

The process 1700 may select (at block 1720), for the UE, a second type of VR based on the set of one or more channel quality measurement reports. The second type of VR may include a set of one or more first type of VRs in the several first type of VRs. The second type of VR, in some embodiments, may be a UE-specific VR. The process 1700, in some embodiments, may receive, from the UE, a message indicating the maximum number of first type of VRs the UE is able to support. The BS, in these embodiments, may select the first type of VRs in the second type of VR based on the maximum number of first type of VRs that the UE is able to support to. For example, the number of first type of VRs in the second type of VR may be less than or equal to the maximum number of first type of VRs that the UE is able to support.

The process 1700 may transmit (at block 1725), to the UE, a second CSI configuration that includes a set of one or more CSI resource sets. Each CSI resource set in the set of CSI resource sets identifies one or more CSI resources for a first type of VR in the set of one or more first type of VRs of the second type of VR. The process 1700 may then end. The second CSI configuration, in some embodiments, may include a CSI resource configuration. The second CSI configuration, in some embodiments, may include a CSI reporting configuration.

In some embodiments, the set of one or more CSI resource sets in the second CSI configuration may include two or more CSI resource sets. The CSI configuration, in these embodiments, may further include a bitmap that includes several bits. Each bit in the bit map may identify whether a corresponding first type of VR in the several first type of VRs is included in the set of one or more first type of VRs of the second type of VR.

The process 1700, in some embodiments, may receive, from the UE, a PMI for the second type of VR after the BS transmits the second CSI configuration to the UE. The second CSI configuration may allow the UE to identify the second type of VR from the set of one or more CSI resource sets that is included in the second CSI configuration. The UE may then determine the PMI based on the second type of VR.

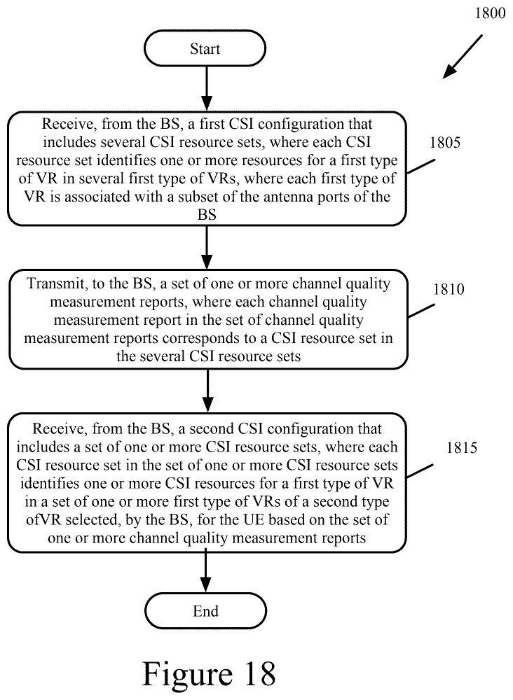

FIG. 18 is a flowchart illustrating an example method/process 1800 performed by a UE for receiving an indication of a second type of VR that is selected by the BS for the UE based on one or more first type of VRs, according to an example implementation of the present disclosure. With reference to FIG. 18, the process 1800 may be performed by at least one processor of a UE 101A-101C, shown in FIG. 1.

The process 1800 may receive (at block 1805) from the BS, a first CSI configuration that includes several CSI resource sets. The BS may include an antenna array with several antenna ports. Each CSI resource set may identify one or more CSI resources for a first type of VR in several first type of VRs. Each first type of VR may be associated with a subset of the antenna ports of the BS. Each CSI resource may correspond to an antenna port of the BS. In some embodiments, the subsets of the antenna ports of the BS that are associated with each first type of VR may be non-overlapping.

The process 1800 may transmit (at block 1810), to the BS, a set of one or more channel quality measurement reports. Each channel quality measurement report in the set of channel quality measurement reports may correspond to a CSI resource set in the several CSI resource sets.

The process 1800 may receive (at block 1815), from the BS, a second CSI configuration that includes a set of one or more CSI resource sets. Each CSI resource set in the set of one or more CSI resource sets may identify one or more CSI resources for a first type of VR in a set of one or more first type of VRs of a second type of VR selected, by the BS, for the UE based on the set of one or more channel quality measurement reports. The process 1800 may then end.

The second CSI configuration, in some embodiments, may include a CSI resource configuration. The second CSI configuration, in some embodiments, may include a CSI reporting configuration. The set of one or more CSI resource sets in the second CSI configuration, in some embodiments, may include two or more CSI resource sets. The CSI configuration, in these embodiments, may further include a bitmap that includes several bits. Each bit in several bits may identify whether a corresponding first type of VR in the several first type of VRs is included in the set of one or more first type VRs of the second type of VR. The process 1800, in some embodiments, may determine a PMI for the second type of VR, and may transmit the PMI to the BS.

In some embodiments, prior to receiving the second CSI configuration, the process 1800 may transmit to the BS a message that indicates the maximum number of first type of VRs the UE is able to support. In these embodiments, the number of the first type of VRs in the set of first type of VRs of the second type of VR may be less than or equal to the maximum number of first type of VRs the UE is able to support.

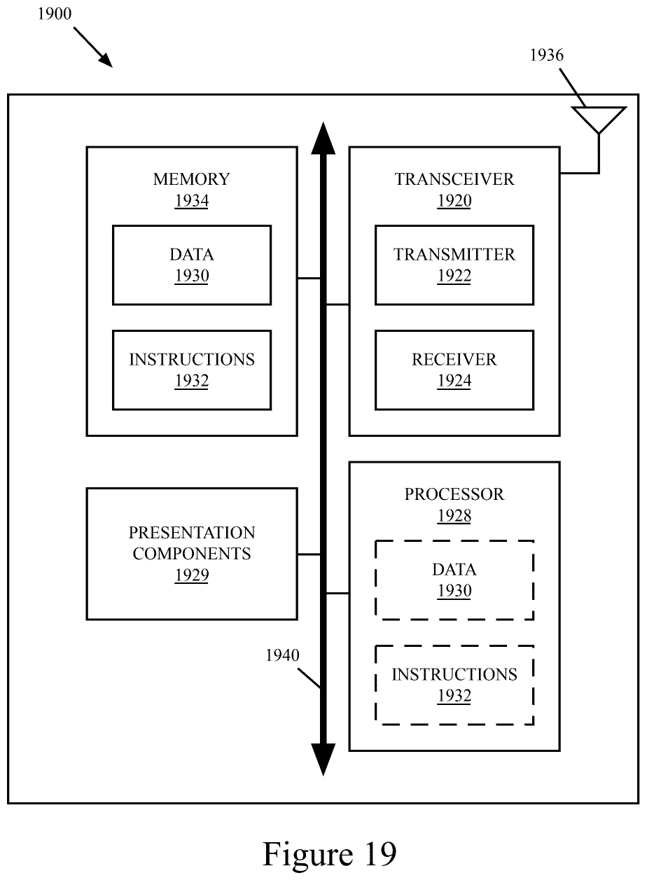

FIG. 19 is a block diagram illustrating a node 1900 for wireless communication, according to an example implementation of the present disclosure. As illustrated in FIG. 19, a node 1900 may include a transceiver 1920, a processor 1928, a memory 1934, one or more presentation components 1929, and at least one antenna 1936. The node 1900 may also include a radio frequency (RF) spectrum band module, a BS communications module, a network communications module, and a system communications management module, Input/Output (I/O) ports, I/O components, and a power supply (not illustrated in FIG. 19).

Each of the components may directly or indirectly communicate with each other over one or more buses 1940. The node 1900 may be a UE or a BS that performs various functions disclosed with reference to FIGS. 1 through 18.

The transceiver 1920 has a transmitter 1922 (e.g., transmitting/transmission circuitry) and a receiver 1924 (e.g., receiving/reception circuitry) and may be configured to transmit and/or receive time and/or frequency resource partitioning information. The transceiver 1920 may be configured to transmit in different types of subframes and slots including, but not limited to, usable, non-usable, and flexibly usable subframes and slot formats. The transceiver 1920 may be configured to receive data and control channels.

The node 1900 may include a variety of computer-readable media. Computer-readable media may be any available media that may be accessed by the node 1900 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1934 may include computer-storage media in the form of volatile and/or non-volatile memory. The memory 1934 may be removable, non-removable, or a combination thereof. Example memory may include solid-state memory, hard drives, optical-disc drives, etc. As illustrated in FIG. 19, the memory 1934 may store a computer-readable and/or computer-executable instructions 1932 (e.g., software codes) that are configured to, when executed, cause the processor 1928 to perform various functions disclosed herein. Alternatively, the instructions 1932 may not be directly executable by the processor 1928 but may be configured to cause the node 1900 (e.g., when compiled and executed) to perform various functions disclosed herein.

The processor 1928 (e.g., having processing circuitry) may include an intelligent hardware device, e.g., a Central Processing Unit (CPU), a microcontroller, an ASIC, etc. The processor 1928 may include memory. The processor 1928 may process the data 1930 and the instructions 1932 received from the memory 1934, and information transmitted and received via the transceiver 1920, the baseband communications module, and/or the network communications module. The processor 1928 may also process information to send to the transceiver 1920 for transmission via the antenna 1936 to the network communications module for transmission to a CN.

One or more presentation components 1929 may present data indications to a person or another device. Examples of presentation components 1929 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment can also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A base station (BS), comprising:
an antenna array comprising a plurality of antenna ports;
one or more non-transitory computer-readable media storing one or more computer-executable instructions; and
at least one processor coupled to the one or more non-transitory computer-readable media, and configured to execute the one or more computer-executable instructions to cause the BS to:
define a plurality of first type of visibility regions (VRs), each first type of VR in the plurality of first type of VRs being associated with a subset of the plurality of antenna ports of the BS;
transmit, to a user equipment (UE), a first channel state information (CSI) configuration comprising a plurality of CSI resource sets, each CSI resource set in the plurality of CSI resource sets identifying one or more CSI resources for a first type of VR in the plurality of first type of VRs;
receive, from the UE, a set of one or more channel quality measurement reports, each channel quality measurement report in the set of channel quality measurement reports corresponding to a CSI resource set in the plurality of CSI resource sets;
select, for the UE, a second type of VR based on the set of one or more channel quality measurement reports, the second type of VR comprising a set of one or more first type of VRs in the plurality of first type of VRs; and
transmit, to the UE, a second CSI configuration comprising a set of one or more CSI resource sets, each CSI resource set in the set of CSI resource sets identifying one or more CSI resources for a first type of VR in the set of one or more first type of VRs of the second type of VR.

2. The BS of claim 1, wherein the at least one processor is further configured to execute the one or more computer-executable instructions to cause the BS to:
receive, from the UE, a precoding matrix indicator (PMI) for the second type of VR.

3. The BS of claim 1, wherein the at least one processor is further configured to execute the one or more computer-executable instructions to cause the BS to:
receive, from the UE, a message indicating a maximum number of first type of VRs the UE is able to support,
wherein selecting the second type of VR further comprises selecting a number of first type of VRs in the second type of VR based on the maximum number of first type of VRs the UE is able to support.

4. The BS of claim 1, wherein:
the set of one or more CSI resource sets in the second CSI configuration comprises two or more CSI resource sets, and
the CSI configuration further comprises a bitmap comprising a plurality of bits, each bit in the plurality of bits identifying whether a corresponding first type of VR in the plurality of first type of VRs is included in the set of one or more first type of VRs of the second type of VR.

5. The BS of claim 1, wherein each CSI resource corresponds to an antenna port of the BS.

6. The BS of claim 1, wherein the second CSI configuration comprises a CSI resource configuration.

7. The BS of claim 1, wherein the second CSI configuration comprises a CSI reporting configuration.

8. The BS of claim 1, wherein:
each first type of VR comprises a cell-specific VR,
the plurality of first type of VRs are indicated, by the BS, to the UE, through the first CSI configuration, and
the first CSI configuration is transmitted to the UE during one of an initial access by the UE, a random-access by the UE, or an initial connection establishment between the UE and the BS.

9. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from a base station (BS) comprising an antenna array comprising a plurality of antenna ports, a first channel state information (CSI) configuration comprising a plurality of CSI resource sets, each CSI resource set in the plurality of CSI resource sets identifying one or more CSI resources for a first type of visibility region (VR) in a plurality of first type of VRs, each first type of VR in the plurality of first type of VRs being associated with a subset of the plurality of antenna ports of the BS;
transmit, to the BS, a set of one or more channel quality measurement reports, each channel quality measurement report in the set of channel quality measurement reports corresponding to a CSI resource set in the plurality of CSI resource sets; and
receive, from the BS, a second CSI configuration comprising a set of one or more CSI resource sets, each CSI resource set in the set of one or more CSI resource sets identifying one or more CSI resources for a first type of VR in a set of one or more first type of VRs of a second type of VR selected, by the BS, for the UE, based on the set of one or more channel quality measurement reports.

10. The UE of claim 9, wherein the at least one processor is further configured to execute the one or more computer-executable instructions to cause the UE to:
determine a precoding matrix indicator (PMI) for the second type of VR; and
transmit, to the BS, the PMI for the second type of VR.

11. The UE of claim 9, wherein:
the set of one or more CSI resource sets in the second CSI configuration comprises two or more CSI resource sets, and
the CSI configuration further comprises a bitmap comprising a plurality of bits, each bit in the plurality of bits identifying whether a corresponding first type of VR in the plurality of first type of VRs is included in the set of one or more first type of VRs of the second type of VR.

12. The UE of claim 9,
wherein the at least one processor is further configured to execute the one or more computer-executable instructions to cause the UE to:
prior to receiving the second CSI configuration, transmit, to the BS, a message indicating a maximum number of first type of VRs the UE is able to support; and
wherein a number of the first type of VRs in the set of first type of VRs of the second type of VR is less than or equal to the maximum number of first type of VRs the UE is able to support.

13. The UE of claim 9, wherein the second CSI configuration comprises a CSI resource configuration.

14. The UE of claim 9, wherein the second CSI configuration comprises a CSI reporting configuration.

15. A method performed by a base station (BS) that includes an antenna array comprising a plurality of antenna ports, the method comprising:
defining a plurality of first type of visibility regions (VRs), each first type of VR in the plurality of first type of VRs being associated with a subset of the plurality of antenna ports of the BS;
transmitting, to a user equipment (UE), a first channel state information (CSI) configuration comprising a plurality of CSI resource sets, each CSI resource set in the plurality of CSI resource sets identifying one or more CSI resources for a first type of VR in the plurality of first type of VRs;
receiving, from the UE, a set of one or more channel quality measurement reports, each channel quality measurement report in the set of channel quality measurement reports corresponding to a CSI resource set in the plurality of CSI resource sets;
selecting, for the UE, a second type of VR based on the set of one or more channel quality measurement reports, the second type of VR comprising a set of one or more first type of VRs in the plurality of first type of VRs; and
transmitting, to the UE, a second CSI configuration comprising a set of one or more CSI resource sets, each CSI resource set in the set of CSI resource sets identifying one or more CSI resources for a first type of VR in the set of one or more first type of VRs of the second type of VR.
